(19) United States
(12) Patent Application Publication
(10) Pub. No.: US 2008/0312817 A1
(43) Pub. Date: Dec. 18, 2008

(54) Navigation apparatus and navigation program

(75) Inventor: Hiroshi Kawauchi, Kariya-City (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/153,639

(22) Filed: May 22, 2008

(30) Foreign Application Priority Data
Jun. 8, 2007 (JP) 2007-152488
Mar. 28, 2008 (JP) 2008-086457

(51) Int. Cl. G01C 21/36

(52) U.S. Cl. 701/201

(57) ABSTRACT

A common word in Japanese syllabary is extracted from multiple items of the destination data, and the common words thus extracted are stored as search keywords. Furthermore, the search keywords are assigned to each potential destination which may be a search target. When a search is made for a destination, those keywords which match the input characters, in whole or in part, are extracted, and the keywords thus extracted are displayed as selectable keys, thus allowing the location candidates to be narrowed down based upon the input characters and the selected keywords. The priority levels of the extracted location candidates are adjusted according to priority score adjustment rules set by operator input, and the location candidates are displayed in the form of a list in descending order of priority. This allows the extracted location candidates to be displayed in the form of a list in an order matching the user's preference.

### INCORPORATION BY REFERENCE

The disclosure of Japanese Patent Application No. 2007-152488 filed on Jun. 8, 2007, and Japanese Patent Application No. 2008-086457 filed on Mar. 28, 2008 including the specification, drawings and abstract is incorporated herein by reference in its entirety.

### BACKGROUND OF THE INVENTION

1. Field of the Invention

The present invention relates to a navigation apparatus and a navigation program, in particular to an apparatus and program which allow the user to search for a location by inputting a character string.

2. Description of the Related Art

In recent years, navigation systems which provide travel guidance have become widely used. A conventional navigation apparatus executes the functions of: searching for a route from a starting point to a destination; detecting the location of the user's vehicle using GPS (Global Positioning System) satellites, gyro sensor, etc.; displaying the route to the destination and the current location of the user's own vehicle on a map; etc.

Japanese Patent Application Publication No. H11-271084 describes a navigation apparatus which allows the user to narrow down the destination candidates by inputting the name in Japanese syllabary, address, or phone number of a destination via a touch panel. With such an arrangement, after the completion of the search by inputting the name of the destination in Japanese syllabary or genre, the destination candidates are displayed on a display screen in the form of a list, which allows the user to select a desired destination from among the listed candidates.

### SUMMARY OF THE INVENTION

However, when the user searches for a place to be set as the destination by inputting characters for the name of the destination (Japanese syllabary or letters of the alphabet), the user must input the characters of the name one by one. This requires the user to perform repeated operations, which require a certain amount of operation time and amounts to a troublesome procedure. Furthermore, such an arrangement does not permit the user to make a search if the name thus input includes any character (letter or syllable) which does not match the name of the place which is the destination.

On the other hand, some cellular phones etc., have a function of supplementing the input by displaying candidates for the characters to be input in the next step. However, with such an arrangement, the characters thus displayed are only the character candidates obtained by a prefix search and the characters which have already been input. That is to say, such an arrangement does not permit the user to narrow down the candidates using a portion of the character string other than the prefix. Furthermore, cellular phones need to provide a general-purpose search function in order to allow various character strings to be input. In many cases, such an arrangement also displays unnecessary words as the supplemented word candidates, leading to poor ease-of-use.

On the other hand, when the navigation apparatus displays a list of candidates for the destination, narrowed down by making a search, the navigation apparatus displays the location candidates in alphabetical order or in the order of the Japanese syllabary, or according to the map coordinates (e.g., in order of from the north to the south). With such an arrangement, the location candidates are displayed in a fixed order. Furthermore, in a case in which a great number of location candidates have been detected, in many cases, the location candidates thus displayed include many other than the candidates most likely to be selected, leading to poor ease-of-use.

Accordingly, it is an object of the present invention to provide a navigation apparatus capable of displaying location candidates matching the user's preference, as a narrowed down list of location candidates, limited to higher-priority candidates, to simplify a search for the destination.

According to the present invention, the display priority level is determined based upon circumstances as related to each of the destination candidates which have been extracted by search. Furthermore, the destination candidates are displayed in descending order of priority. Such a system allows the extracted location candidates to be displayed in an order matching the user's preference.

### BRIEF DESCRIPTION OF THE DRAWINGS

FIG. 1 is a block diagram of an embodiment of a navigation apparatus according to the present invention;

FIG. 2 is a schematic diagram of the destination data (location information) stored in a destination data file;

FIG. 3 is a schematic diagram of a keyword data file;

FIG. 4 is a diagram which outlines the priority score adjustment rules;

FIG. 5 is a schematic diagram of an input device and a display;

FIG. 6 is a flowchart of one embodiment of a destination setting routine;

FIG. 7A and FIG. 7B are diagrams showing examples of destination setting screens;

FIGS. 8A-8D are diagrams showing different lists displayed in accordance with season adjustment rules (one example of the priority score adjustment rules);

FIGS. 9A-9D are diagrams showing different lists displayed in accordance with weather adjustment rules;

FIGS. 10A-10C are diagrams showing different lists displayed in accordance with time adjustment rules;

FIGS. 11A-11C are diagrams showing different lists displayed in accordance with calendar adjustment rules;

FIGS. 12A-12C are diagrams showing different lists displayed in accordance with current location adjustment rules;

FIG. 13A-13C are diagrams showing different lists displayed in accordance with destination adjustment rules;

FIGS. 14A and 14B are diagrams showing lists displayed in accordance with location adjustment rules;

FIGS. 15A and 15B illustrate lists displayed in accordance with genre adjustment rules;

FIG. 16 is a schematic diagram of destination data (location information) as organized and stored in a destination data file in a navigation apparatus modified to US specifications;

FIG. 17 is a schematic diagram of keywords as organized and stored in a keyword data file in the navigation apparatus modified to US specifications;

FIG. 18 is a schematic diagram of an input device and a display in a navigation apparatus modified to US specifications;

FIGS. 19A and 19B are schematic diagrams of examples of destination setting screens in a navigation apparatus modified to US specifications;

FIGS. 20A-20D are diagrams illustrating different lists displayed in accordance with season adjustment rules (one form of the priority score adjustment rules) in a navigation apparatus modified to US specifications;

FIGS. 21A-21D are diagrams illustrating different lists displayed in accordance with weather adjustment rules (another form of the priority score adjustment rules) in the navigation apparatus modified to US specifications;

FIGS. 22A-22D are diagrams illustrating different lists displayed in accordance with time adjustment rules in a navigation apparatus modified to US specifications;

FIGS. 23A-23C are diagrams illustrating different lists displayed in accordance with calendar adjustment rules in a navigation apparatus modified to US specifications;

FIGS. 24A-24C are diagrams illustrating different lists displayed in accordance with current-position adjustment rules in a navigation apparatus modified to US specifications;

FIGS. 25A-25C are diagrams illustrating different lists displayed in accordance with destination adjustment rules in a navigation apparatus modified to US specifications;

FIGS. 26A and 26B are diagrams illustrating different lists displayed in accordance with location adjustment rules in a navigation apparatus modified to US specifications; and

FIGS. 27A and 27B are diagrams illustrating display of a list in accordance with genre adjustment rules in a navigation apparatus modified to US specifications.

### DETAILED DESCRIPTION OF THE PREFERRED EMBODIMENTS

In recognition of the fact that only particular words (names of locations etc.) can be used as a search target in operation of a navigation apparatus, the present invention provides a system in which common words in Japanese syllabary, for example, are extracted from multiple items of the destination data as search keywords, and the keywords thus extracted are stored in a keyword data file as keyword data. Examples of various such common keywords include “supermarket”, “university”, “information”, “center”, “land”, “bank”, “amusement park”, “golf”, etc., each of which is included in the names of multiple locations. In this manner, suitable search keywords are assigned to each item of the destination data which may be a search target.

It should be noted that the keywords are provided for each of “name of destination”, “address”, and “genre”, and are stored in the keyword data file in a manner that allows the user to differentiate therebetween. In other words, keywords for the “name”, the “address”, and the “genre” are assigned to each item of the destination data.

With such an arrangement, in searching for a destination, a search is made for the keywords which match the input characters, and the matching keywords are displayed. The keywords thus extracted are displayed in the form of selectable keys from which the user selects a desired keyword, thereby eliminating need for subsequent input operation. For example, such an arrangement allows the user to select a keyword of three or more characters by an operation requiring only two steps, in a minimum case, i.e., an operation requiring only inputting a single character and a selection step, thereby providing a shortcut operation.

The input of characters narrows the field of keywords and those locations (destinations) stored in association with a keyword, at least a part of which matches the input characters, are extracted as the location candidates. Such an arrangement allows location candidates to be extracted based upon a character input in Japanese syllabary, even if the name of location includes this character at an intermediate position. For example, if the user were to input the character “ni” in hiragana, the restaurant name “Missoni for miso-nikomi” includes the keyword “nikomi” in hiragana, and accordingly, this keyword is extracted. Thus, such an arrangement allows a search to be made based upon a part of a keyword which the user remembers.

Furthermore, additional keywords are stored in association with each (main) keyword stored in the keyword data file as related keywords. Such an arrangement allows the location candidates to be extracted using a word, even if the word does not match the destination (name, address, genre) which is a search target in Japanese syllabary.

As described above, such an arrangement also permits the user to select a keyword or related keyword extracted based upon the input characters, thereby eliminating need for another input operation. Furthermore, such an arrangement allows the user to search for locations over a larger area. Thus, in many respects, such an arrangement simplifies the input operation required of the user. Furthermore, a keyword dictionary is created based upon the location information for the navigation, which provides a suitable number of keywords for a location search, thereby allowing the user to input data and to make a search suited to the navigation programs.

Furthermore, a priority level is assigned to each keyword, which determines the listing order. For example, the priority may be set according to the frequency with which the keyword is used as the name of a destination in Japanese syllabary. With such an arrangement, the priority level is determined beforehand based upon actual statistics for frequency of usage.

Subsequently, when the user selects the determination key after the input of characters or the selection of the keyword for narrowing-down the field of destination candidates, the extracted candidates are displayed in the form of a list in descending order of priority after the priority level of each of the extracted destination candidates is adjusted according to priority adjustment rules based upon, for example, “season” or “location”. Thus, such an arrangement allows the extracted destination candidates to be displayed in the form of a list and in an order matching the user's preference.

### First Embodiment

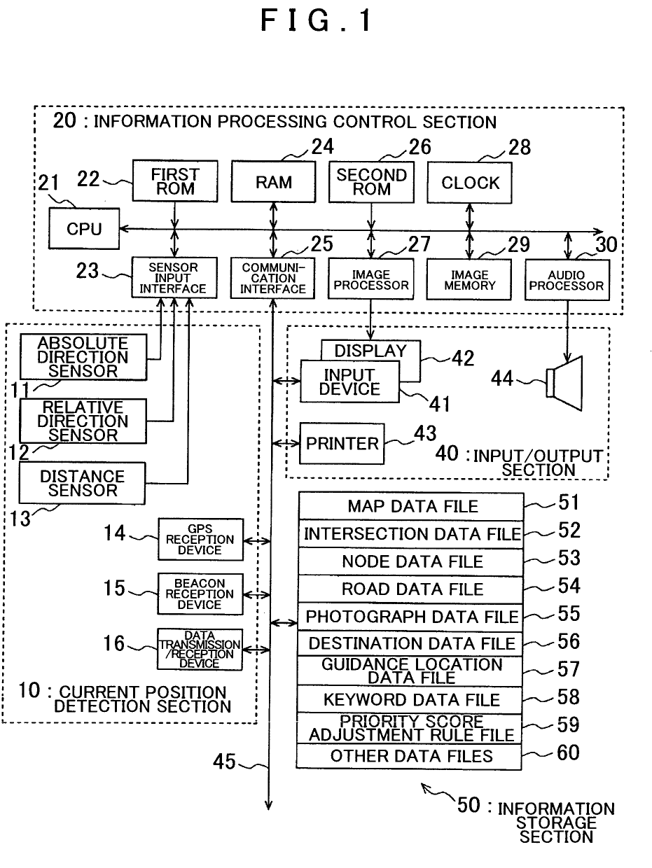

FIG. 1 illustrates the overall configuration of a navigation apparatus according to the present invention mounted on a vehicle. As shown in FIG. 1, the navigation apparatus includes a current location detection section 10, an information processing control section 20, an input/output section 40, and an information storage section 50. The current location detection section 10 includes, for example, an absolute direction sensor 11 in the form of a geomagnetic sensor which detects North as a magnetic direction and thereby detects the direction of the vehicle. Any desired mechanism may be employed as the absolute direction sensor 11, as long as it can detect the absolute direction.

A relative direction sensor 12 detects whether or not the vehicle has turned at an intersection. Examples of sensors which may be employed as the relative direction sensor 12 include an optical rotation sensor and a potentiometer type sensor mounted on a rotatable component of the steering mechanism, and/or an angle sensor mounted in association with a steered wheel. Also, a gyro sensor may be employed to detect the change in angle as angular speed. Any sensor may be employed as long as it can detect an angle which changes relative to a reference angle (absolute direction).

Examples of sensors which may be employed as distance sensor 13 include a sensor which detects and counts the rotations of the wheel and a mechanism which detects acceleration which is then is twice integrated. Any desired mechanism may be employed as the distance sensor 13 as long as it can measure the distance of movement of the vehicle.

A GPS (Global Positioning system) reception device 14 receives signals from man-made satellites. The GPS reception device 14 receives various items of information such as the time of signal transmission, reception device position information, speed of movement of the reception device, the direction of movement of the reception device, etc.

A beacon reception device 15 receives signals transmitted from transmission devices installed in particular locations. In particular, the beacon reception device 15 receives VICS information, which allows the user to obtain information useful in driving the vehicle, examples of which include traffic jam information, current location information, parking information, etc.

A data transmission/reception device 16 communicates with other devices external to the vehicle via a telephone line or radio, which allows information to be exchanged therebetween. For example, the data transmission/reception device 16 may be an automobile telephone, ATIS, or VICS, and may provide GPS correction, communication between vehicles, etc. In other words, device 16 allows information useful in driving the vehicle to be input and output.

The information processing control section 20 performs computation and control operations based upon the information input from the current location detection section 10 and the input/output section 40 and the information stored in the information storage section 50. Furthermore, the information processing control section 20 executes control programs to output computation results to an output unit such as a display 42, a printer 43, a speaker 44, or the like. The central processing unit (CPU) 21 is the central unit for overall control of the entire navigation apparatus.

First ROM 22 stores a navigation program, the execution of which provides detection of the current location, search for a route, display of guidance, etc.

The input interface 23 receives information from the current location detection section 10.

RAM 24 is a storage unit for storing information that has been input by a user, such as information on the destination and information on the locations of transit points that have been input through an input device. Furthermore, the RAM 24 stores the results of computation by the CPU 21 based upon the information input by the user, the route search results, and the map information read out from the information storage section 50.

The communication interface 25 inputs and outputs the information obtained from the current location detection section 10, in particular, the information obtained externally (from the vehicle).

Second ROM 26 also stores a program for navigation, specifically, a navigation program providing voice guidance. The image processor 27 is a processing unit which converts the vector information generated by the CPU into image information. Clock 28 counts time. Image memory 19 is a mechanism which stores the image information processed by the image processor 27. Audio processor 30 processes audio information read out from the information storage section 50, and outputs the audio information thus processed to the speaker 44.

The input/output section 40 includes: an input device 41 which allows the user to input data such as the destination, the locations which the vehicle is to pass, search conditions, etc; a display 42 which displays images; a printer 43 which prints out information; and the speaker 44 which outputs audio information (guidance). The input device 41 may include: a touch panel on the surface of the display 42; a touch switch; a joy stick; a key switch, etc. The display 42 displays a map of the area around the current location, various operation screens, and a driving route to the destination.

The information storage section 50 is connected to the information processing control section 20 via a data transmission bus 45 and stores a map data file 51, an intersection data file 52, a node data file 53, a road data file 54, a photograph data file 55, a destination data file 56, a guidance location data file 57, a keyword data file 58, a priority adjustment rule file 59, and other data files 60.

In general, the information storage section 50 includes a DVD-ROM or CD-ROM which is an optical storage medium, a hard drive which is a magnetic storage medium, or the like. Also, various other information storage media may be used, examples of which include a magneto-optic disk, semiconductor memory, etc.

The map data file 51 contains stored map data such as data for national, regional and local (residential) maps. Thus, the stored map data includes roads, specifically, main roads, highways, narrow streets, etc., and landmarks and facilities. The residential map is a town map which shows graphics representing the outline of buildings, the names of the streets, etc. The term “narrow street” as used herein refers to relatively narrow roads, as compared to a national road or state road, or to roads of a width of which is equal to or smaller than a predetermined width, and having no traffic rules such as limitation to one-way traffic.

The node data file 53 stores geographical coordinate data etc., for nodes constituting routes. The road data file 54 stores data for road features such as the road location, road type, the number of lanes, connections with other roads, etc. The photograph data file 55 stores image data of photographs of the places to be visually displayed, such as various facilities and sightseeing spots, and principal intersections. The guidance location data file 57 stores the guidance data for the locations where the user needs the guidance such as the content of the road signs posted along the roads and the information for junctions and intersections.

The destination data file 56 stores data used for making a search for a destination, examples of which include principal sightseeing spots, buildings, the places and facilities which can be selected as a destination, such as a corporate office, which are listed in a phone book.

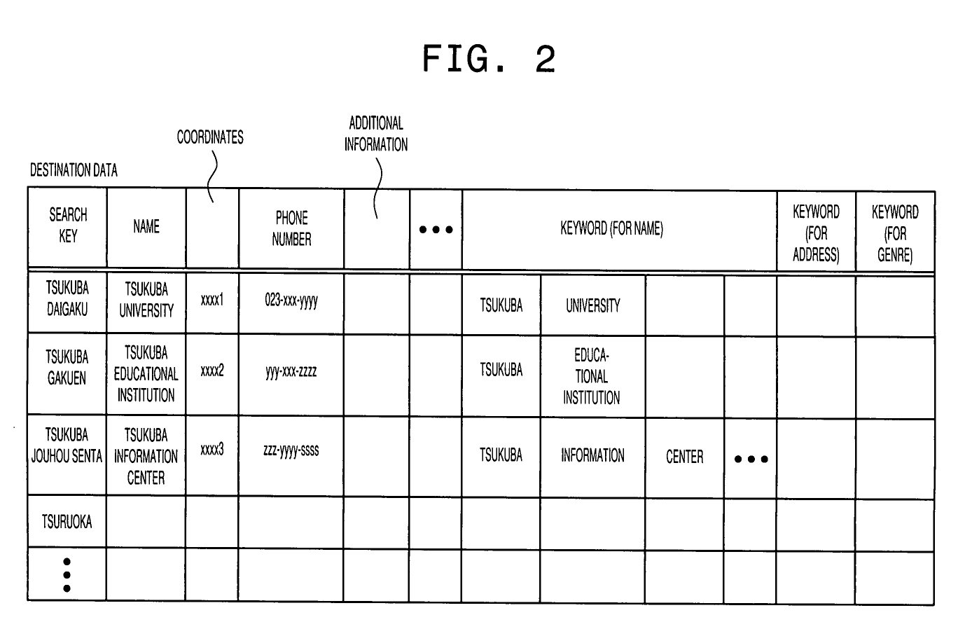

FIG. 2 is a schematic diagram of the destination data (location information) stored in the destination data file 56. The destination data includes, for each potential destination, a search key, name, geographical coordinates, phone number, additional information etc., and the keyword(s) employed in the present embodiment.

The search key is the name of the destination input in Japanese syllabary. The input device (Japanese syllabary keys on the touch panel in the present embodiment) allows the user to input such a search key. For Japanese syllabary, the search key may be in katakana or hiragana.

The graphical coordinates are x-y coordinate information which consists of the latitude and longitude of the destination. The “additional information” includes detailed data for the destination.

The keywords for the name, address, and genre are stored in a classified manner and include particular keywords that correspond to the destination. Examples of keywords for the name are “Tsukuba” and “university” for the destination “Tsukuba University”. Likewise, the keywords “Kac-Donald's”, “Tokyo station” etc., are stored for the destination “Kac-Donald's Tokyo station shop”. Similarly, keywords are stored for the address and genre, respectively, of the destination. The term “genre” as used herein has a hierarchical structure for classifying potential destinations. Specifically, the genre include a “food and drink” class, a “shopping and rental” class, a “lodging” class, a “sightseeing and amusement” class, and an “automobile service facility” class, etc. Furthermore, the “shopping and rental” class has sub-classes, e.g., a “convenience store” class, a “supermarket” class, a “discount store” class, “department store” class, etc. Such a genre is defined and stored beforehand for each destination.

In some cases, the abbreviation, nickname, etc., are stored as additional keywords for a destination, to allow extraction even if such a keyword in Japanese syllabary includes no syllable which matches the name of the place. For example, in a case in which the name of destination is “game arcade Kogami AB head office”, the stored keywords would include “game arcade”, “Kogami”, and “AB head office”. In some cases, a keyword “gei-sen”, which is an abbreviated Japanese slang word, is stored as an additional keyword.

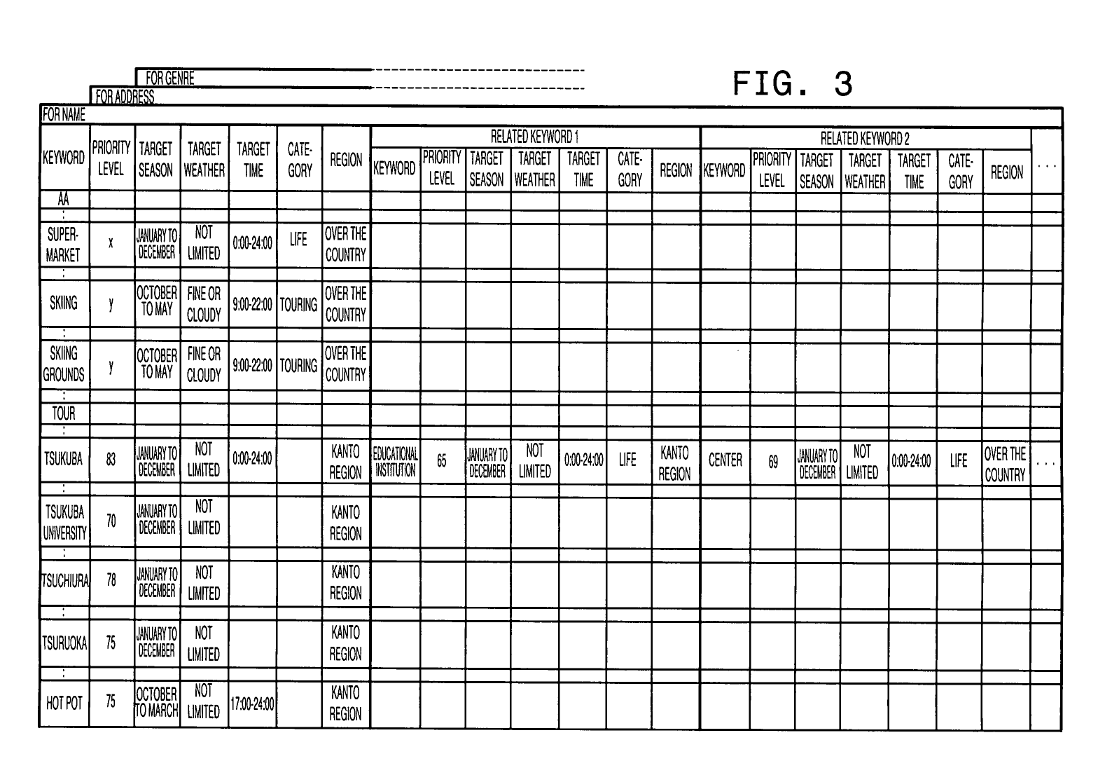

FIG. 3 is a schematic diagram which shows keywords stored in the keyword data file 58 in the same way as those stored in the destination data file 56, i.e. the keyword data file 58 stores keywords for the name, the address, and the genre. Each keyword is composed of a word (syllable) corresponding to a destination. For example, when the number of times a given word appears in the names, addresses, etc., of the destinations is equal to or greater than a predetermined number, such a word is extracted as a keyword. The Japanese abbreviated slang words “kon-bini”, which means a “convenience store”, and “gei-sen”, which means a “game arcade”, are stored as additional keywords.

In the present embodiment, the keywords narrowed down according to the input character string are displayed as the input keys, as described later. Furthermore, priority is defined for each keyword, which determines the order of display of the search keys. Moreover, priority adjustment conditions are defined for adjusting the priority based upon current circumstances (time, place, etc.), examples of which include a “season” condition, “weather” condition, “time” condition, “category” condition, and “region” condition. The content of the conditions with respect to such items are defined for each keyword. For example, the priority of the destination candidate including a keyword “hot pot” is defined as “75” points. Furthermore, the season condition for the keyword “hot pot” is set as “October to March”. In a case in which the current month is within this season condition, i.e. October to March, the priority is incremented by a predetermined number of points n, e.g., 3 points, thereby adjusting the priority from “75” points to “78” points. Also, related keywords can be set for a (main) keyword. The words which are used with high frequency as the search keywords, in addition to the main keyword, are set as related keywords. For example, the words which are a part of or all the words of the name of the destination are set as related keywords. Specifically, the related keywords “educational institution”, “center”, etc., are set as related keywords for the main keyword “Tsukuba”.

In the present embodiment, when the user selects one of the keywords narrowed down in accordance with the input character string, the related keywords that correspond to the keyword thus selected are displayed as search keys which are the next selection candidates (input candidates). Also, in a case in which the number of the all the keywords narrowed down in accordance with the input character string is less than a predetermined number (e.g., the maximum number of the keywords which can be displayed on a screen), the related keywords that correspond to the keywords thus narrowed down are displayed.

As shown in FIG. 3, like the keywords, the priority and priority adjustment conditions for adjusting the priority, i.e., a “season” condition, “weather” condition, “time” condition, “category” condition, and “region” condition, are set for each related keyword as necessary. Each related keyword is stored in association with the corresponding destination. Such a related keyword is used in the same way as the first keyword.

In the present embodiment, the keyword and its related keywords are used for an AND (plural word) input by which a search may narrow down the destination candidates. Specifically, in a case in which the keyword “A” and the related keyword “a” have been selected, the destination data containing the keyword “A” and (“AND”) the related keyword “a” is extracted, thereby narrowing down the destinations. In the same way, the keyword and its related keywords set for the name, the address, and the genre of the destination are used for making an AND input, by which a search is made for a narrowed group of destination candidates.

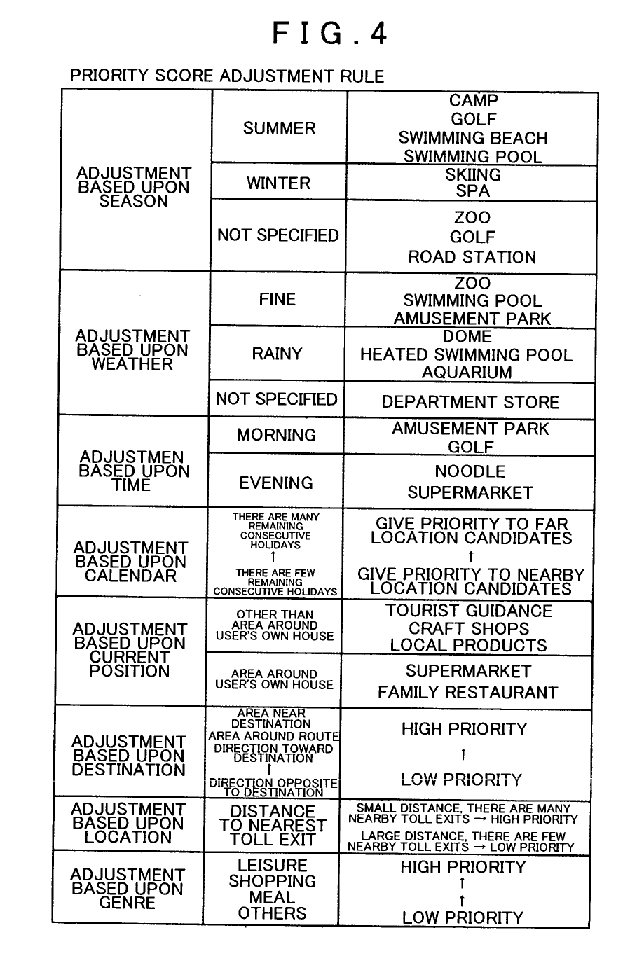

FIG. 4 is a schematic diagram of the priority score adjustment rules showing the priority score adjustment rules for making a search as including “time rule”, “location rule”, “weather rule”, “destination rule”, and other adjustment rules. All the adjustment rules apply. Alternatively, defaults may be set for all the adjustment rules, while permitting the user to select the desired rules to be applied. Such an embodiment allows the destination candidates (location candidates) to be displayed in the form of a list in an order matching the user's preference. Also, the system may be modified to allow the user to appropriately select a keyword for each item, the priority (score) of which is to be adjusted, thereby displaying the destination candidates in an order even better matching the user's preference.

As shown in FIG. 4, when the season in which the search is made matches summer, the priority scores of the location candidates (destination candidates) including keywords associated with, for example, “camp”, “golf”, “swimming beach”, or “swimming pool” are raised. In the same way, when the season in which the search is made matches winter, the priority scores of the location candidates including keywords associated with “skiing” or “spa”, are raised. In a case in which the user has not applied the season rule, the priority scores of the location candidates including keywords associated with, for example, “zoo”, “golf”, and “road station (along the route)” are increased. It should be noted that, when the user determines that the score adjustment mode should not be used, no priority score adjustment rule is applied.

Also, in a case in which the weather is fine, the priority scores of location candidates including keywords associated with, for example, “zoo”, “swimming pool”, or “amusement park” are increased. On the other hand, in a case in which the weather is rainy, the priority scores of the location candidates including keywords associated with “dome”, “heated swimming pool”, or “aquarium” are increased. On the other hand, when the user has not applied the weather rule, the priority scores of location candidates including keywords associated with “department store” are increased. The weather can be detected based upon output signals output from various kinds of sensors. For example, the weather may be detected using an illuminometer, a rain sensor, a wiper driving signal, time, etc.

Also, when the current time is in the morning, the priority scores of the location candidates including keywords associated with, for example, “amusement park” and/or “golf” are raised. On the other hand, when the current time is in the evening, the priority scores of location candidates including keywords associated with, for example, “noodle”, or “supermarket” are increased.

Also, when the search is made on a calendar date before or during consecutive holidays, the priority scores of more remote (further away) location candidates are increased according to the number of remaining holidays. With such an arrangement, when there are few remaining holidays, the priority scores of the nearer destination candidates are raised. Consider, for example, a case in which the current location is Nagoya and today is the first day of consecutive holidays, the priority scores of the location candidates including keywords associated with “land”, “sea”, etc., which are associated with more remote destination candidates are raised. On the other hand, in a case in which today is the last day of consecutive holidays or an ordinary day, the priority scores of destination candidates including keywords associated with “store”, “shop”, etc., which are neighboring places, are raised.

Also, in a case in which the current location is near the user's pre-registered residence (e.g., an area of a 100-km radius around the user's home), the priority scores of the destination candidates including keywords associated with, for example, “supermarket” or “family restaurant” are raised. On the other hand, if the current location is outside that area defined around the user's home, the priority scores of destination candidates including keywords associated with, for example, “tourist guidance”, “craft shops”, or “local products” are raised.

After the destination has been set, the priority scores of the location candidates located near the destination, the location candidates located along a driving route to the destination thus set, and the location candidates located in the direction toward the destination, are raised. On the other hand, the priority scores of the location candidates located in a direction opposite that toward the destination are reduced (the priority stores are decremented).

Also, the priority scores for those location candidates closest to the nearest toll exit, and in accordance with increase in the number of the nearby toll exits, are increased. Conversely, the priority scores of the location candidates are reduced in accordance with increased distance between the location candidate and the nearest toll exit, and according to a reduced number of nearby toll exits.

When the user selects the “genre” rule, the priority scores of genre items are raised in order of, for example, “meal”, “shopping”, and “leisure” items. Furthermore, the priority scores of the other genre items are reduced. Examples of other priority adjustment rules include a rule in which the priority score is

raised according to reduction in the number of characters (remaining characters) in the candidate name, after subtraction of those that match the input characters or the keywords thus selected. For example, when the user selects the keywords “Sagami” and “child”, the priority score is raised according to reduction in the number of remaining characters other than the keywords “Sagami” and “child”. As a result, the priority is set for the destination candidates in order of “Sagami child sea”, “Sagami child land”, and “Sagami child land station”.

With the priority score adjustment rules described above, in a case in which the score is raised, the score is incremented by a predetermined value m (e.g., m=5). On the other hand, in a case in which the score is reduced, the score is decremented by the predetermined value m. The score which has not been incremented or decremented by the predetermined value m is that priority level of the keyword stored in the destination data of each location candidate. In a case in which there are multiple keywords, the maximum value of the priority scores thus adjusted is employed. The priority score of the location candidate not associated with a keyword is set to, for example, “50” points.

The priority adjustment rules shown in FIG. 4 have been described by way of example only. Determination is made with at least one of these rules. The rules used for determination may be set beforehand or may be selected by the user. It should be noted that the rules are used for priority adjustment independently of each other.

To provide route guidance, the navigation apparatus first detects the current location by means of the current location detection section 10. Furthermore, the navigation apparatus reads the map information for the vicinity of the current location from the map data file 51 stored in the information storage section 50, and displays a map on the display 42. After setting the destination in accordance with a routine to be described later, the information processing control section 20, functioning as a search unit, searches for multiple driving route candidates from the current location to the destination. Then, the multiple driving route candidates thus calculated are highlighted on the map thus displayed on the display 42. When the driver selects one of the driving route candidates, the driving route thus selected is stored in the RAM 24.

Alternatively, the information processing control section 20 may transmit the current vehicle location (or input starting point) and destination to the information processing center and receive the results of a search made by the information processing center for a driving route to the destination. In such an embodiment, communication with respect to the destination and the driving route is performed via the communication interface 25 by wireless communication.

During driving of the vehicle, the current location detected by the current location detection section 10 is traced to provide route guidance. In this operation, the vehicle location on the map is determined by map matching between the road data for the driving route obtained in the search and the current location as detected by the current location detection section 10. Furthermore, a map of the area around the current vehicle location is displayed on the display 42, and the driving route thus obtained in the search and the current location are indicated on the displayed map. A determination is then made whether or not the route guidance is to be performed based upon the relationship between the driving route thus obtained in the search and the current location. Specifically, in a case in which straight travel is to continue for at least a predetermined distance, a determination is made whether or not driving route guidance, such as that for predetermined turning point candidates etc., or region guidance, is to be provided. When a determination has been made that such guidance is to be performed, the guidance is provided both visually (on the display 42) and audibly (by voice from speaker 44).

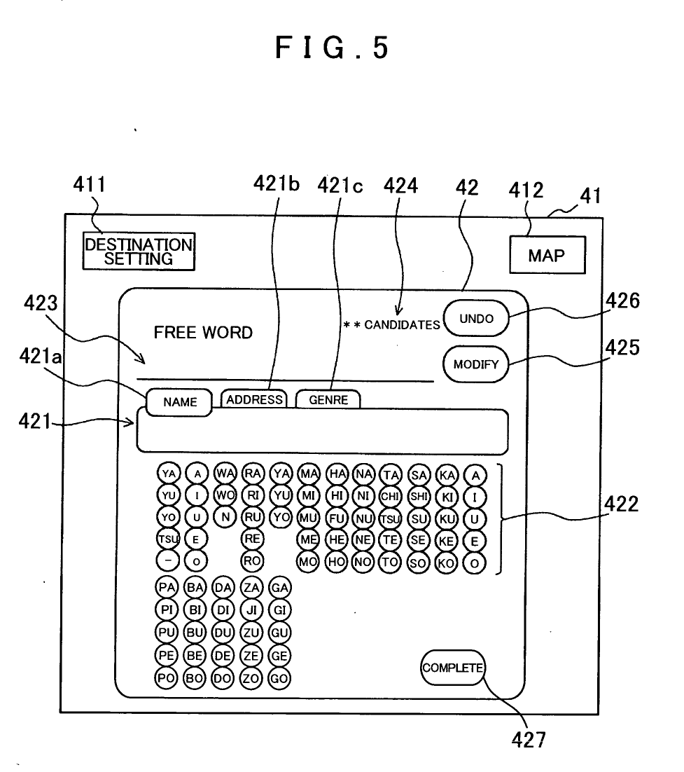

Next, destination setting routine according to the present embodiment will be described with reference to FIG. 5. The display 42 displays various menu screens such as a destination setting screen which allows the user to set the destination and a map screen which displays a map of the area around the current location. The display 42 includes a touch panel provided on the display screen, which allows the user to select a desired item by directly touching the displayed item with a finger. A fixed frame of the input device 41 surrounds the outer edge of the display 42 and, in the upper region of the fixed frame, a destination setting key 411 and a map key 412, which allows the user to display a map of an area around the current location, are provided as push buttons (hardware (mechanical) keys).

The destination setting key 411 is a key for displaying a destination setting screen which allows the user to set the destination, the locations which the vehicle is to pass, etc. (which will collectively be referred to as “destination” hereinafter). When the user operates the destination setting key 411, the destination setting routine of the present embodiment is executed. It should be noted that the destination thus set in the destination setting routine according to the present embodiment is used for making a route search. Furthermore, the destination thus set is used for displaying the destination itself and the location candidates around the current location on the map screen.

The screen shown on the display 42 in FIG. 5 is the destination setting screen. The items displayed on the destination setting screen include a keyword box 421, an input keyboard 422, an input character field 423, a candidate number field 424, a modification key 425, an undo key 426, and a completion key 427. The keyword box 421 displays the keywords (including the related keywords) narrowed down according to the input character string. The keywords are thus displayed in the keyword box 421 as input keys, which permits the user to select a desired keyword by touching a displayed keyword. It should be noted that the keywords and the related keywords are displayed in a manner which allows the user to differentiate therebetween. The keyword box 421 actually includes three different keyword boxes, i.e., a keyword box for the name, a keyword box for the address, and a keyword box for the genre. Such an arrangement permits the user to select a desired name tab 421a, an address tab 421b, and a genre tab 421c, thereby displaying a keyword field thus narrowed down in accordance with the tabs thus selected.

The input keyboard 422 is composed of keys which allow the user to input characters in Japanese syllabary and may be a display of a numeric pad or function keys.

The input character field 423 displays a character string input via the input keyboard 422 or the keyword selected from the keyword box. The input character string and the keyword are displayed in a manner which allows the user to differentiate therebetween.

The candidate number field 424 displays the number of location candidates (destination data) narrowed down according to the input character string or the keyword displayed in the input character field.

The modification key 425 is a key which allows the user to modify the input character string and the keyword thus selected.

The undo key 426 is a key which allows the user to return to the previous state of the last operation.

The completion key 427 is a key which allows the user to display a list of the destination candidates thus narrowed down according to the input character string or the selected keyword.

It should be noted that, on the destination setting screen shown in FIG. 5, the character string “Free Word” is displayed on the upper-left side. This means that the user is permitted to freely input characters with respect to the keyword or related keyword, in addition to input of the name of the destination, in order from the first character.

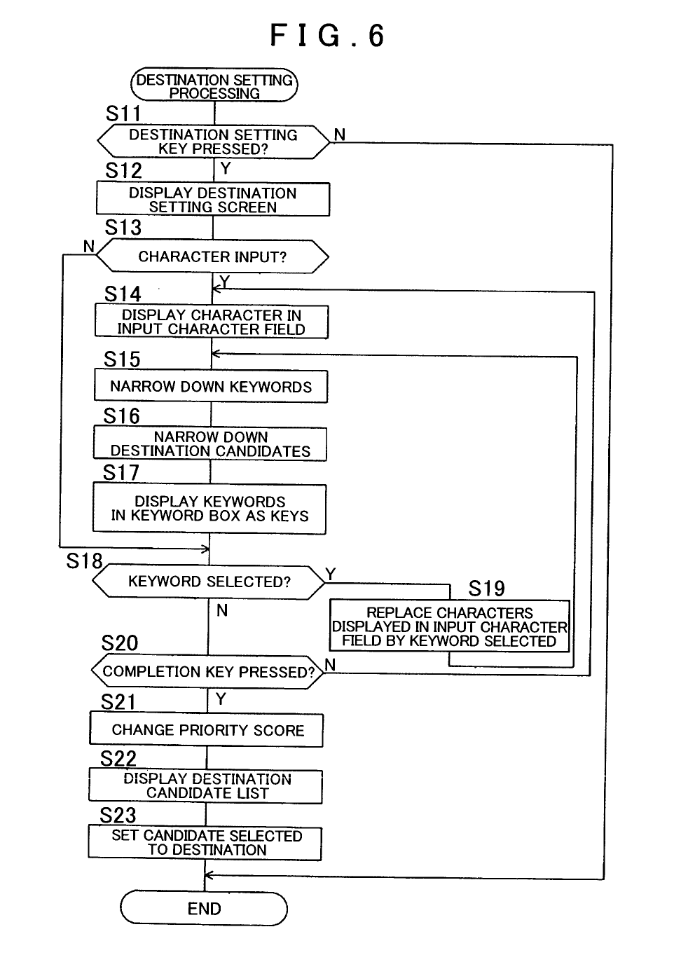

The destination setting routine will now be described with reference to the flowchart of FIG. 6. It should be noted that the flowchart of FIG. 6 does not show the steps of pressing the modification key 425 and the undo key 426 in the destination setting operation. The user is permitted to press the modification key 425 and the undo key 426 at any desired time before pressing the completion key 427. When the user presses the modification key 425, modification processing is executed. On the other hand, when the user presses the undo key 426, undo processing is executed, which returns the screen to the previous state immediately before the last operation. Such processing may be provided in the form of a separate routine.

The information processing control section 20 monitors whether or not the user has pressed (selected) the destination setting key 411 (Step 11). When it is detected that the user has pressed the destination setting key 411 (“YES” in Step 11), the information processing control section 20 displays the destination setting screen shown in FIG. 5 (Step 12), and monitors whether or not characters have been input via the input keyboard 422. When characters have been input (“YES” in Step 13), the information processing control section 20 displays the input characters in the input character field 423 (Step 14), and searches all the keywords stored in the keyword data file 58. When a given keyword matches, in whole or in part, the characters (character string) displayed in the input character field 423, that keyword is extracted, thereby narrowing down the keywords (Step 15). The keywords are narrowed down for each of the “name”, “address”, and “genre”. The keywords thus narrowed down are stored in a predetermined region of the RAM 24.

Subsequently, the information processing control section 20 narrows down the destination candidates (location candidates) based upon the input characters displayed in the input character field and the keywords thus narrowed down. Furthermore, the information processing control section 20 displays the number of the destination candidates, thus narrowed down, in the candidate number field 424 (Step 16). The destination candidates are narrowed down based upon the input characters as follows. In a case in which a part of a given destination candidate matches input characters (one or more characters) displayed in the input character field, such a destination candidate is extracted, thereby narrowing down the search keys (the name in Japanese syllabary, see FIG. 2) for the destination data. In a case in which a given destination candidate is stored in association with one of the keywords, such a destination candidate is extracted in Step 15, thereby narrowing down the destination data. The input characters and the keywords are used for making an AND (combined phrase) input. The destination data narrowed down based upon the input characters and the keywords is stored in the RAM 24 as the destination candidates.

It should be noted that, when the user inputs the first character, the destination data file 56 is searched. After the user inputs the second character, the destination candidates stored in the RAM 24 are searched. When the RAM 24 is searched, the destination candidates other than those thus extracted are removed (deleted).

The IDs of the destination candidates may be stored in the RAM 24 as the destination candidates, instead of storing all the destination data in the RAM 24. With such an arrangement, in a step for further narrowing down the destination candidates, the destination candidate data is narrowed down with reference to the destination data stored in the destination data file 56 that corresponds to the IDs stored in the RAM 24.

Subsequently, the information processing control section 20 displays the keywords thus narrowed down in the keyword box 421 as the selectable keys (Step 17). The items displayed in the keyword box 421 are the keywords that correspond to any one of the tabs 421a through 421c displayed as the frontmost (bottom line). The keywords, having a part of which matches the input characters or the selected keywords, are extracted and displayed in the keyword box 421. In a case in which the number of keywords thus narrowed down is equal to or less than a predetermined number to be displayed, the keywords related to the matching keywords are also displayed.

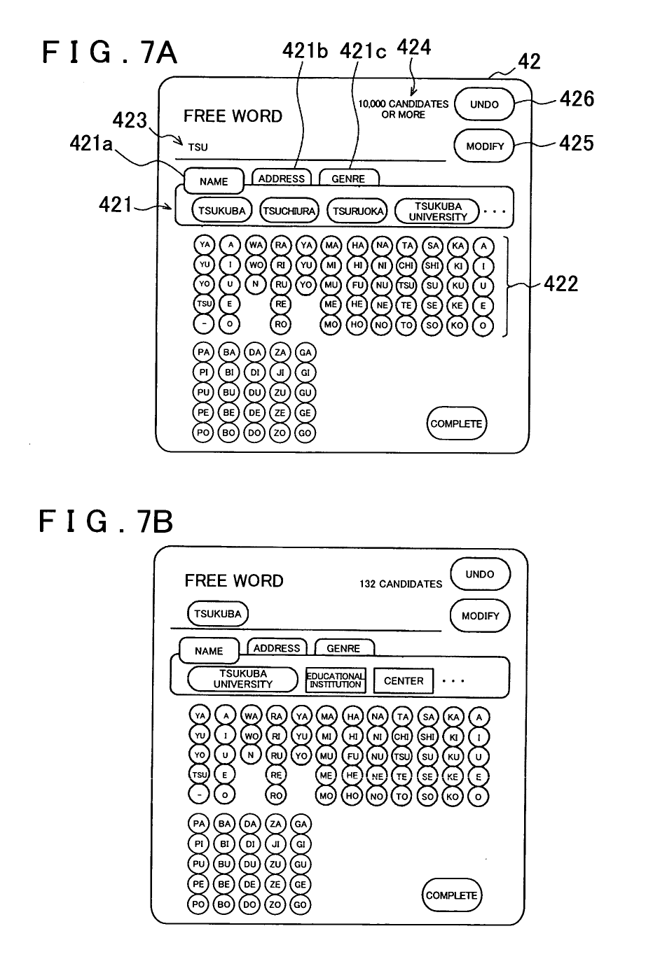

FIG. 7A shows the destination setting screen displayed after the user inputs a character “Tsu” in Japanese hiragana via the input keyboard 422. In this state, the character “Tsu” input in hiragana is displayed in the input character field 423 (Step 14). Furthermore, the keywords (“name” category) such as “Tsukuba”, “Tsuchiura”, “Tsuruoka”, “Tsukuba university”, etc., a part of which matches the character “Tsu” thus input in hiragana, are extracted (Step 15), and displayed in the keyword box 421 of the name tab 421a (step 17).

Upon the user touching the address tab 421b on the destination setting screen shown in FIG. 7A, the keyword box 421 for the “address” category is displayed at the frontmost. Furthermore, the keywords for the address, which have been narrowed down according to the character “Tsu” input in hiragana, are displayed in the keyword box 421.

In Step 17, the information processing control section 20 displays the keywords thus narrowed down in the keyword box 421 according to the priority level of each keyword. The priority level of each keyword is adjusted based upon the current circumstances (season, weather, time, category, region, etc.). With such an arrangement, the keywords are displayed in the keyword box 421 in descending order of priority, after the adjustment of the priority.

The keyword “Tsukuba University” should be displayed at a position preceding the keywords “Tsuchiura” and “Tsuruoka” in order of Japanese syllabary. However, in FIG. 7A, the keywords “Tsuchira” and “Tsuruoka” having higher priority levels (see FIG. 3) are displayed at respective positions before the keyword “Tsukuba University”. Thus, with such an arrangement, the order of display of the keywords is adjusted according to the priority levels, thereby allowing the keywords to be displayed in a manner matching the user's preference. Specifically, in a case in which the current season, time and condition match “summer”, “morning”, and “fine”, the priority levels of particular keywords such as “swimming pool” and “beach” are raised, thereby displaying the keywords in a manner better matching the user's preference.

Returning to FIG. 6, in the next step, the information processing section 20 monitors the next input (selection) (Steps 18 and 20). When the user selects a keyword from among those displayed in the keyword box 421 (“Y” in Step 18), the information processing control section 20 replaces the input characters displayed in the input character field 423 by the keyword thus selected (Step 19). In a case in which a different keyword has already been displayed in the input character field 423 in accordance with the previous operation, the keyword thus newly selected is displayed after the former keyword. In FIG. 7B, it should be noted that the keyword is displayed in a frame that allows the user to differentiate between the keyword and the input character string.

After the display of the keyword in the input character field 423 the routine returns to Step 15. Then, the information processing section 20 narrows down the keywords thus selected (Step 15), and narrows down the destination candidates (Step 16). In Step 15 after the processing in Step 19, the keywords, which have been narrowed down (in Step 15 immediately after Step 14) and are stored in the RAM 24, are searched for those which include the keyword selected in Step 18. The keywords other than the keywords thus extracted are deleted. For example, in a case in which the user has selected the keyword “Tsukuba” in FIG. 7A, the keyword “Tsukuba University” is extracted. Furthermore, the other keywords “Tsuchiura” and “Tsuruoka” are removed from the keywords stored in RAM 24.

Subsequently, the information processing control section 20 further narrows down the destination candidates stored in the RAM 24 based upon the keywords thus selected (Step 16), following which the information processing control section 20 displays the keywords thus narrowed down in Step 15 in the keyword box shown in FIG. 7B. Specifically, FIG. 7B shows the destination setting screen after the user has selected the keyword “Tsukuba” via the destination setting screen shown in FIG. 7A.

The character “tsu” input in hiragana in a frame is replaced by the keyword “Tsukuba”, thereby displaying the keyword “Tsukuba” in the frame. Furthermore, the keyword “Tsukuba University” extracted as a result of a further search is displayed in the keyword box 421. In this case, as shown in FIG. 7B, the keywords including “Tsukuba” include only a single keyword, i.e., “Tsukuba University”. Accordingly, the related keywords “educational institution” and “center”, each of which is associated with the selected keyword “Tsukuba”, are also displayed. In a case in which the total number of the keywords and the related keywords associated with the selected keyword is equal to or less than the predetermined number, the related keywords associated with the extracted keywords are also displayed. The related keywords are displayed, in addition to the main keywords, in descending order of the priority level after each priority level is adjusted based upon the current circumstances (time, place, etc.). It should be noted that the keyword displayed in the keyword field is displayed in an elliptic frame and each related keyword is displayed in a rectangular frame to allow the user to differentiate between them.

Returning to FIG. 6, when the user inputs a character (“NO” in Step 18, and “NO” in Step 20), the routine returns to Step 14. Then, the information processing control section 20 executes those steps following Step 14.

On the other hand, when the user selects the completion key 427 (“YES” in Step 20), the information processing control section 20, serving as a priority determination unit, adjusts, according to the priority score adjustment rules, an example of which is shown in FIG. 4, the priority scores for the destination candidates (destination data) which have been narrowed down in Step 16 and which are stored in the RAM 24 (Step 21). As the priority score before the adjustment, the priority level of a keyword stored associated in correlation with the destination candidate (destination data) is employed. In a case in which there is no keyword associated with the destination candidate, the priority score of such a destination candidate is set to a predetermined value (e.g., 50).

Subsequently, the information processing control section 20 displays the destination candidates on the destination setting screen in the form of a list in descending order of the adjusted priority scores (Step 22). Then, the information processing control section 20 sets the destination candidate, which has been selected by the user from among the destination candidates thus displayed, as the final destination (Step 23). The destination thus determined is stored in a predetermined region of the RAM 24 to complete the process.

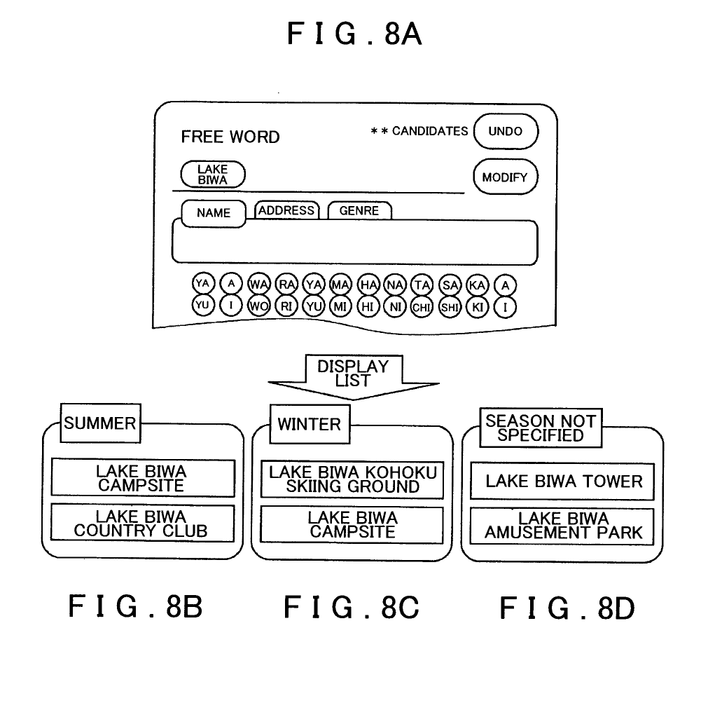

FIGS. 8 through FIG. 15 show examples of different destination candidates displayed in the form of a list based upon the adjusted priority scores, i.e. adjusted according to the priority adjustment rules shown in FIG. 4. FIG. 8A shows “Lake Biwa” as the selected keyword displayed in the input character field 423. When the user selects the completion key 427 in this state, in a case in which the season is currently “summer”, the scores of the destination candidates stored in the RAM 24 are adjusted according to the seasonal priority adjustment rules. Specifically, the priority scores of the location candidates (destination candidates) including keywords associated with, for example, “camp, golf”, “swimming beach”, or “swimming pool” are raised. As a result, in this case, the destination candidates are displayed in the form of a list in order of “Lake Biwa campsite”, “Lake Biwa country club”, etc., as shown in FIG. 8B. On the other hand, when the current season is “winter”, the destination candidates are displayed in the same way in the form of a list in order of “Lake Biwa Kohoku Skiing ground”, “Lake Biwa campsite”, etc., as shown in FIG. 8C. In a case in which the user has not specified the “season”, the destination candidates are displayed in the form of a list in order of “Lake Biwa tower”, “Lake Biwa amusement park”, etc., as shown in FIG. 8D.

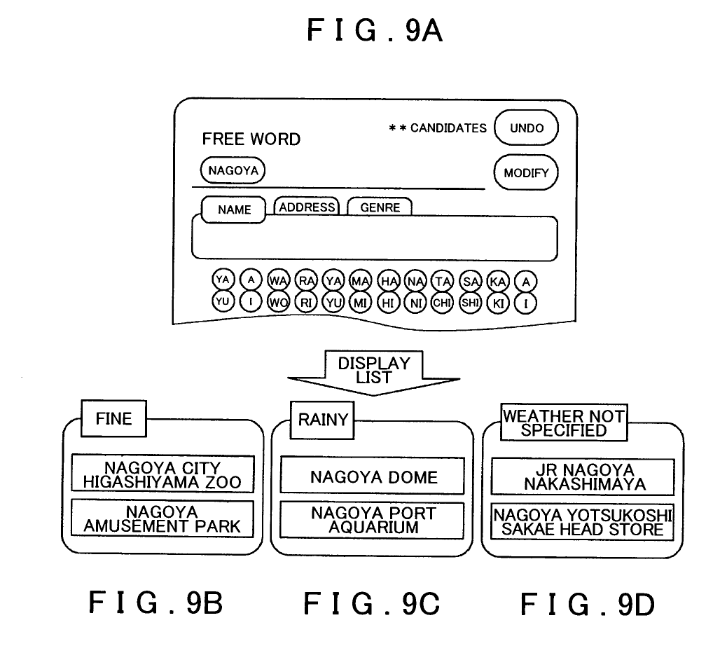

FIGS. 9A and 9B show an example of different destination candidates displayed in the form of a list in a case in which weather adjustment rules are applied as the priority score adjustment rules. As shown in FIG. 9A, when the user selects the completion key 427 with “Nagoya” displayed as the selected keyword, in a case in which the current weather is specified as “fine”, the priority scores of the location candidates (destination candidates) including the keywords associated with, for example, “zoo”, “swimming pool”, and “amusement park” are raised according to the weather adjustment rules. As a result, the destination candidates are displayed in order of “Nagoya city Higashiyama zoo”, “Nagoya amusement park”, etc., as shown in FIG. 9B. On the other hand, in a case in which the current weather is specified as “rainy”, the destination candidates are displayed in the form of a list in the same way, in order of “Nagoya Dome”, “Nagoya port aquarium”, etc., as shown in FIG. 9C. If the user has not specified “weather”, the destination candidates are displayed in the form of a list in order of “JR Nagoya Nakashimaya”, “Nagoya Yotsukoshi Sakae head store”, etc.

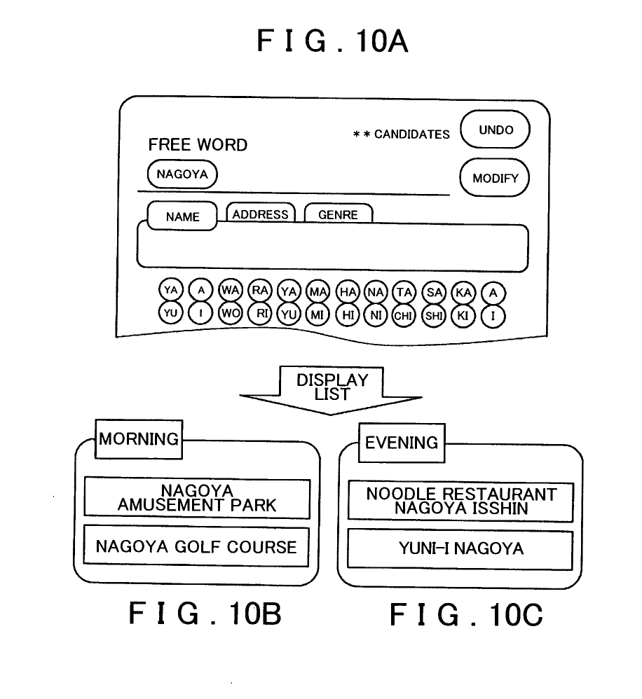

FIGS. 10A-10C show an example of different destination candidates displayed in the form of a list in a case in which time adjustment rules are applied as the priority score adjustment rules. As shown in FIG. 10A, when the user operates the completion key 427 with the selected keyword “Nagoya” displayed, if the time of day is currently “morning”, the priority scores of the location candidates (destination candidates) including the keywords associated with, for example, “amusement park” and “golf” are raised according to the time adjustment rules. As a result, the destination candidates are displayed in order of “Nagoya amusement park”, “Nagoya golf course”, etc., as shown in FIG. 10B. On the other hand, in a case in which the current time of day matches “evening”, the destination candidates are displayed in the form of a list in the same way, in order of “Noodle restaurant Nagoya Isshin”, “Yuni-i Nagoya”, etc.

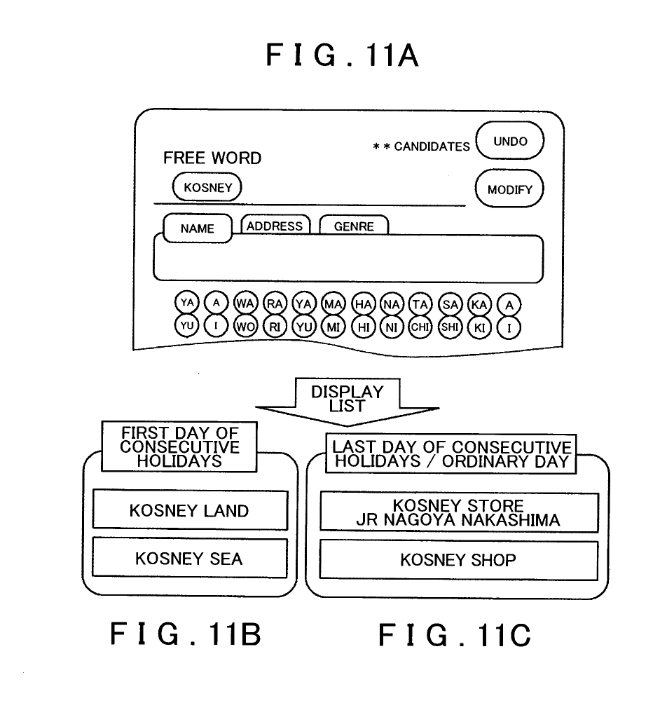

FIGS. 11A-11C show an example of different destination candidates displayed in the form of a list in a case in which calendar adjustment rules are applied as the priority score adjustment rules. As shown in FIG. 11A, when the user selects the completion key 427 with the selected keyword “Kosney” displayed, if today is the first day of consecutive holidays, according to the priority score adjustment rules, the destination candidates are displayed in the form of a list in descending order of distance from the current position, e.g., in order of “Kosney land”, “Kosney sea”, etc., as shown in FIG 11B. On the other hand, if today is the last day of consecutive holidays or a non-holiday, the destination candidates are displayed in ascending order of distance from the current position, e.g., in order of “Kosney store JR Nagoya Nakashima”, “Kosney shop”, etc., as shown in FIG. 11.

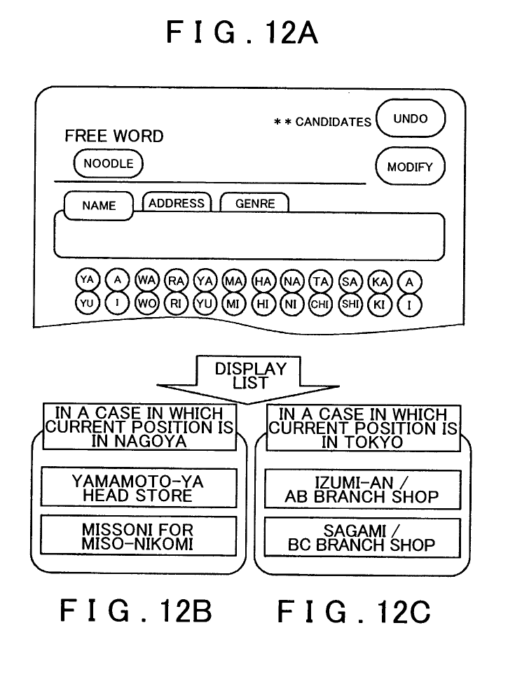

FIGS. 12A-12C show an example of different destination candidates displayed in the form of a list when current location adjustment rules are applied as the priority score adjustment rules. As shown in FIG. 12A, when the user selects the completion key 427 with the selected keyword “noodle” displayed, assuming the user's own home is located in Tokyo, and the current location of the vehicle is in Nagoya, a determination is made that the current location of the vehicle is far from the user's home, and the destination candidates are displayed in order of “Yamamoto-ya head store”, “Missoni for miso-nikomi”, etc., including the keywords associated with “tourist guidance”, “craft shops”, or “local products”, as shown in FIG. 12B. On the other hand, if the current location of the vehicle is in Tokyo, a determination is made that the current location is near the user's home, and the destination candidates are displayed in order of “Izumi-An/AB branch shop”, “Sagami/AB branch shop”, etc., including the keywords associated with “supermarket” or “family restaurant”, as shown in FIG. 12C.

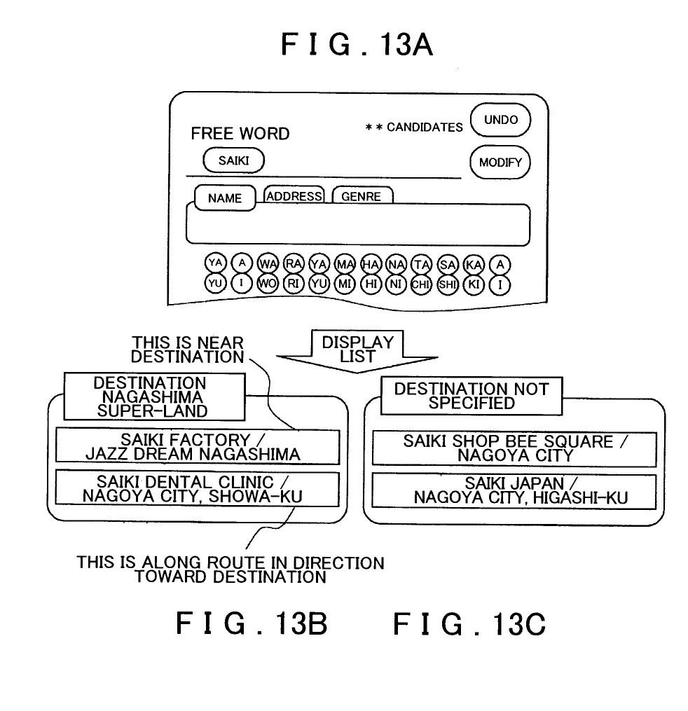

FIGS. 13A-13C show an example of different destination candidates displayed in the form of a list in a case in which destination adjustment rules are applied as the priority score adjustment rules. As shown in FIG. 13A, when the user selects the completion key 427 while the selected keyword “Saiki” is displayed, if “Nagashima Super-land” has already been set as the destination, the location candidates are displayed in order of “Saiki Factory / Jazz Dream Nagashima” located near the destination, and “Saiki Dental Clinic/Nagoya-city Showa-ku” located in the direction toward the destination, as shown in FIG. 13B, according to the priority score adjustment rules which raise the priority levels of the location candidates near the destination, the location candidates near the route, and the location candidates in the direction of travel toward the destination. On the other hand, in a case in which the user has not set the destination, the location candidates are displayed in order of, for example, “Saiki shop Bee Square / Nagoya city”, “Saiki Japan / Nagoya city, Higashi-ku”, etc., each of which is located around Nagoya which is the current location.

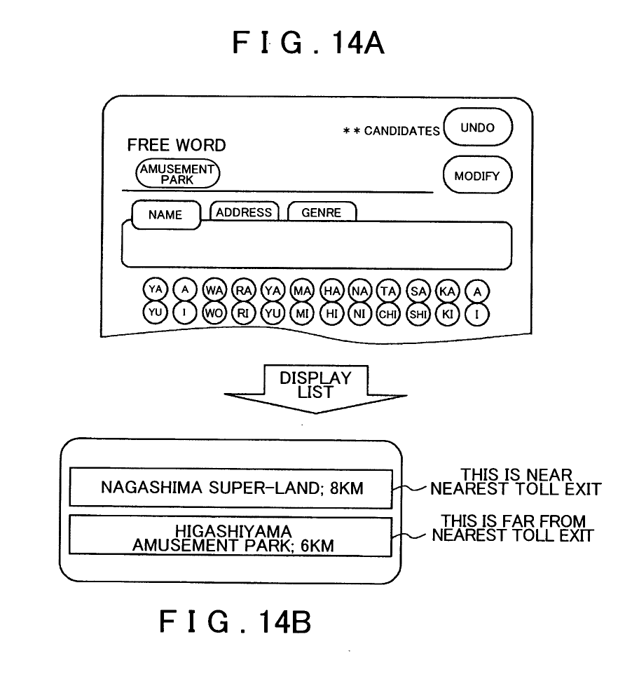

FIGS. 14A and 14B show an example of different destination candidates displayed in the form of a list (menu) in a case in which location adjustment rules are applied as the priority score adjustment rules. As shown in FIG. 14A, the selected keyword is “amusement park”, assuming the user's own home is in Nagoya city, Naka-ku, and the current location is in Nagoya, as shown in FIG. 14B, the destination candidates are displayed in ascending order of the distance between the location candidate and the nearest toll exit, e.g., in order of “Nagashima Super-Land; 8 km”, and “Higashiyama amusement park; 6 km”. It should be noted that the distance information displayed in the list, i.e., “8 km”, and “6 km” are the distances between the respective places and the current location. In this case, “Nagashima Super-Land” is displayed at a higher priority level, regardless of the distance from the current location, since its distance from the toll exit is shorter.

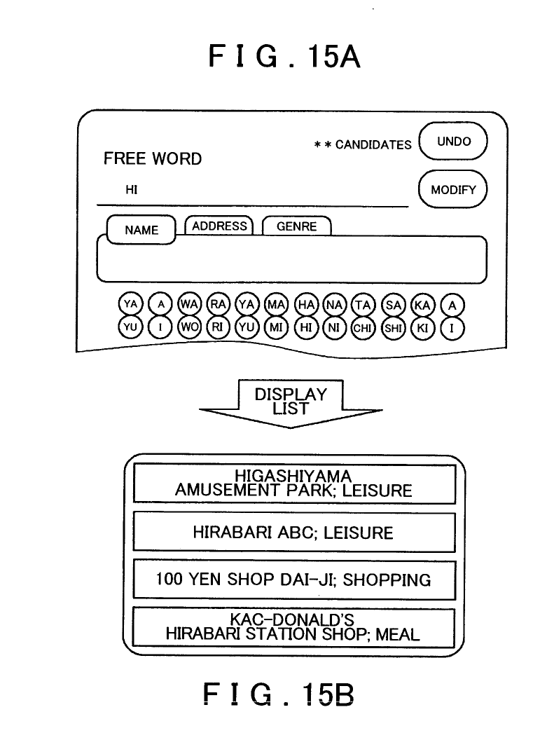

FIGS. 15A and 15B show an example of different destination candidates displayed in the form of a list in a case in which genre adjustment rules are applied as the priority score adjustment rules. As shown in FIG. 15A, when the user operates the completion key 427 when the character “Hi” has been input in hiragana, if the user's own home thus registered as in Nagoya city, Naka-ku, the destination candidates are displayed in the form of a list according to the priority score adjustment rules which give higher priority in order of, for example, “meal”, “shopping” and “leisure”. As a result, the destination candidates are displayed in the form of a list in order of “Higashiyama amusement park; leisure”, “Hirabari ABC; leisure”, “100-yen shop Dai-ji; shopping”, “Kac-Donald's Hirabari station shop; meal”, etc., as shown in FIG. 15B.

As described above, the listing order is adjusted by applying the priority score adjustment rules, thereby allowing the destination candidates to be displayed in the form of a list (menu) in an order more suitable for the user. Furthermore, as described above, such an arrangement allows the user to change the priority score adjustment rules to be applied and the keywords with respect to the item to which the priority score adjustment rules are to be applied, thereby displaying a list in a form more suitable to the user's preference.

In the embodiment described above current circumstances (“season”, “weather”, “time”, “genre”, and “region”), based upon which the current priority of each keyword is adjusted, are stored in the keyword data file 58, and the rules for determining the listing order, in which the destination candidates are displayed in the form of a list, are stored in the priority score adjustment rule file 59. Alternatively, such circumstances (conditions) and the rules for determining the listing order may be provided in a common form.

Such rules may be stored in the keyword data file or stored as adjustment rules in an independent form (independent file). Alternatively, such rules may be incorporated into a program.

Further, while in the above-described embodiment each keyword is stored in the destination data, alternatively, an ID (Identification Number) may be assigned to each keyword stored in the keyword data file, and only the ID, stored with the destination data.

Further, while the embodiment described above has an arrangement in which the keywords are stored with respect to “name”, “address”, and “genre”, and the keywords are narrowed down and displayed for each of “name”, “address”, and “genre”, alternatively, one or two from among the “name”, “address”, and “genre” may be used.

### Second Embodiment

The first embodiment of the navigation apparatus was described as intended for use in Japan. More specifically, the first embodiment is described as a navigation apparatus modified to Japanese specifications, as including the input keyboard 422 having Japanese syllabary keys which allow the user to input data in increments of Japanese syllables, and as storing data in the destination data file 56 for searching for destinations in Japan. However, the environment in which this navigation apparatus can be used is not restricted to Japan. The specifications of the input device 41 and the various data sets may be modified for use in any desired country or region, thereby providing the aforementioned input function and keyword data in a form suited for use in countries other than Japan.

The second embodiment of a navigation apparatus, modified to US specifications as an example of a navigation apparatus for foreign countries other than Japan, will now be described. The system configuration of the navigation system and the routine for destination setting according to the second embodiment are basically the same as those according to the first embodiment. Those components of the second embodiment which are the same as components of the first embodiment are denoted by the same reference numerals, and description thereof will be omitted. Only the differences between the two embodiments will be explained.

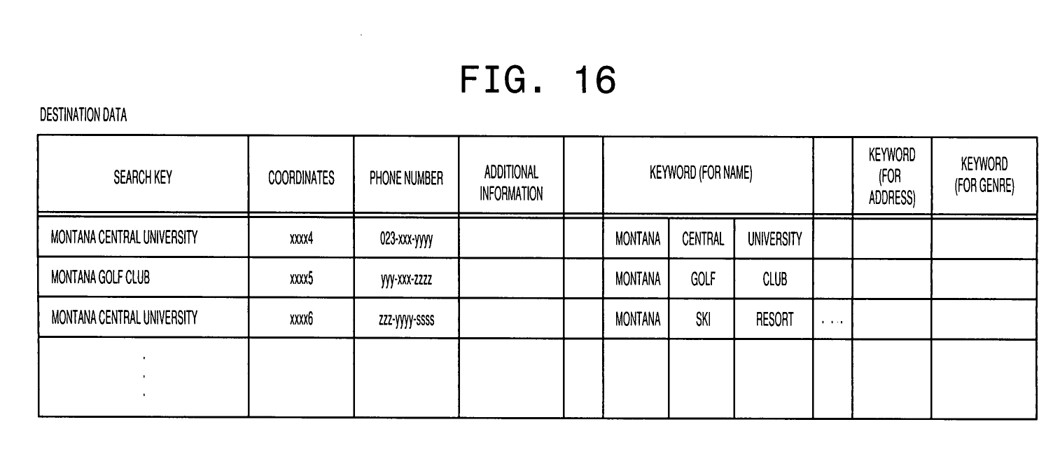

FIG. 16 is a schematic diagram of the content and structure of the destination data (location information) stored in the destination data file 56. As shown in FIG. 16, with the navigation apparatus modified to US specifications, the name of each item stored as the destination data is itself registered as a search key. Furthermore, in each search key according to the US specifications, each word is separated by a space, which differs from the search keys designed for Japanese specifications. Each search key is a “name” of a destination, which is to be associated with input data input by means of an input device (in the second embodiment, a touch panel having alphabetic keys). While search keys may be provided in a mixed case, a search is made without a case-sensitive function. In the second embodiment, the destination data file 56 stores the names of potential destinations in the US.

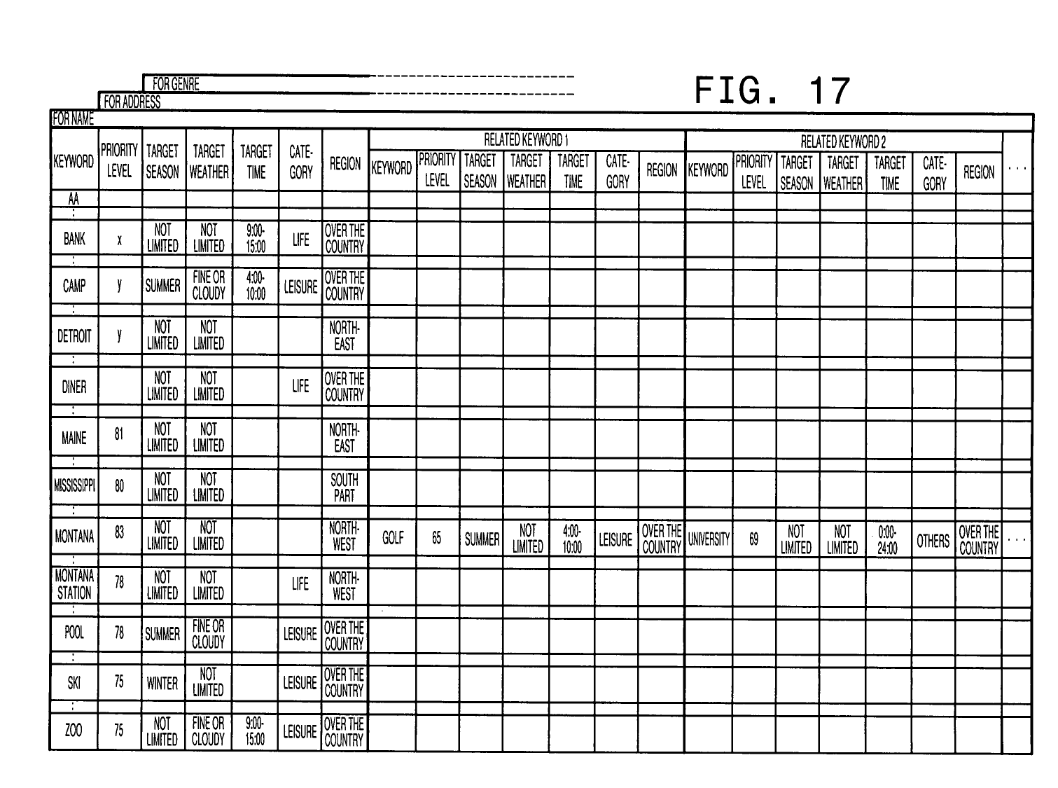

FIG. 17 is a schematic diagram which shows the content and structure of the keywords stored in the keyword data file 58. Each keyword is composed of words, each of which is a component of the name of an item of the destination data. As shown in FIG. 17, with the navigation apparatus modified to US specifications, like the first embodiment, priority is defined for each keyword provided in the form of an alphabetical character string. For example, the priority of a destination candidate including a keyword “Montana” is defined as “83” points. Furthermore, the region is set as “the Northwest”. Accordingly, in a case in which the current location is within the Northwest, the priority level is incremented by a predetermined number of points n, e.g., 3 points, thereby adjusting the priority level from “83” points to “86” points. Also, related keywords can be set for the former keyword. The words which are used with high frequency as the search keywords, in addition to the former keyword, are set as such related keywords. For example, the words which are a part of or all the words of the name of the destination are set as the related keywords. Specifically, words such as “golf”, “university”, etc., are correlated as related keywords for the keyword “Montana”.

It should be noted that the time of year that corresponds to the “season” item defined in the keyword data file 58 is set such that it matches the season in the target country or region where the navigation apparatus is to be used. For example, with the navigation apparatus designed for Japan, the period from December to February is set as “winter”. On the other hand, with the navigation apparatus modified to specifications for Australia, which is in the southern hemisphere, from June to August is set to “winter”. Also, the “time” item in the keyword data file 58 is set such that it matches the season in the target country or region for which the navigation apparatus is intended. For example, in the countries and regions implementing daylight saving time, the “time” is set ahead one hour during the season/period of daylight saving time.

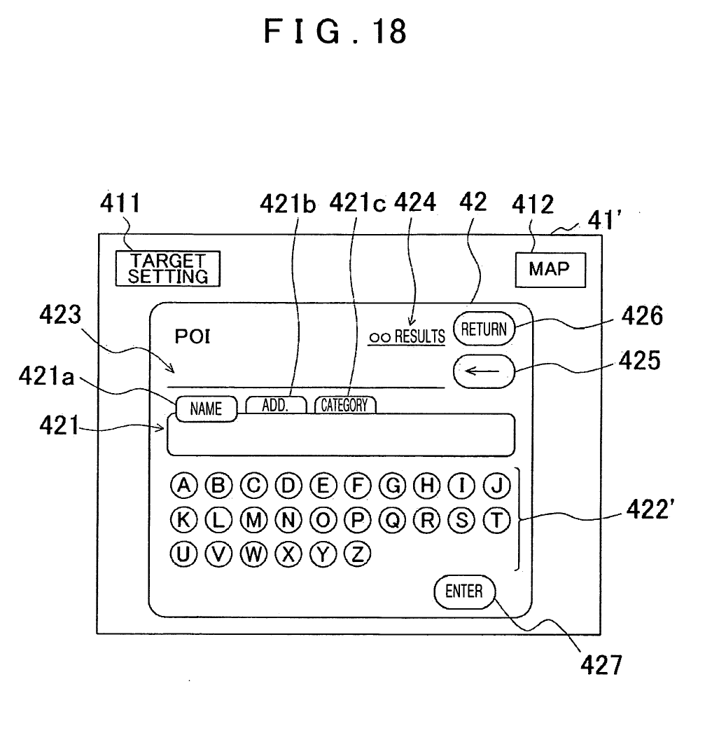

FIG. 18 shows a navigation apparatus modified to US specifications, including an input device 41′ and a display 42. In the navigation apparatus modified to US specifications, as shown in FIG. 18, each item is displayed in English. However, the keys and display regions having the same functions as those of the first embodiment (FIG. 5) are denoted by the same reference numerals. As shown in FIG. 18, the input keyboard 422′ is formed of keys that allow the user to input letters of the Latin alphabet from “A” to “Z”.

With the navigation apparatus including the input device 41 and various data modified to US specifications, the destination setting routine is executed in the same way as in the aforementioned first embodiment (FIG. 6). It should be noted that, in the second embodiment, the user inputs letters of the alphabet (character string) via the input keyboard 422′, and the aforementioned destination data file 56 and the keyword data file 58, modified to US specifications, are used as the reference data.

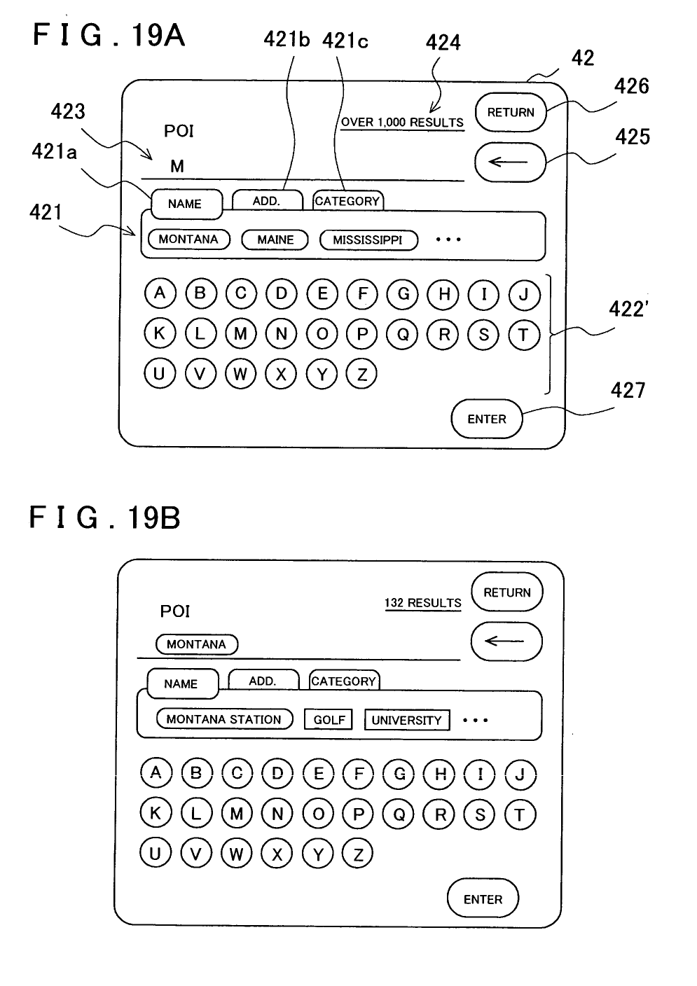

FIGS. 19A and 19B show an example of the display in the destination setting following Step 17 in the navigation apparatus modified to US specifications. FIG. 19A shows the destination setting screen displayed after the user inputs an alphabetic letter “M” via the input keyboard 422′. Thus, the letter “M” is displayed in the input character field 423. Furthermore, the keywords (names) such as “Montana”, “Maine”, “Mississippi”, etc., a part of each of which matches the input character “M”, are extracted and displayed in the keyword box 421 of the name tab 421a. Upon the user touching the address tab 421b on the destination setting screen shown in FIG. 19A, the keyword box 421 for the “address” category is displayed in the first line and, the keywords for the address, which have been narrowed down according to the input character “M”, are displayed in the keyword box 421.

With such an arrangement, the keywords thus narrowed down are displayed in the keyword box 421 as selectable keys. Furthermore, the priority level of each keyword is adjusted based upon the current situation (season, weather, time, category, region, etc.) with reference to the priority score adjustment rules (FIG. 4), in the same way as in the first embodiment. With such an arrangement, the keywords are displayed in the keyword box 421 in descending order of priority of the keywords after the adjustment of the priorities. The keyword “Maine” should be displayed at a position before the keywords “Mississippi” and “Montana” in alphabetical order. However, in FIG. 19A, the keyword “Montana” having a higher priority level (see FIG. 17) is displayed at the top position. As described above, with the navigation apparatus modified to US specifications, the display order of the keywords is adjusted according to the priority values, thereby allowing the keywords to be displayed in a manner matching the user's preference.

In a case in which the user has selected the keyword “Montana” from among those displayed in the keyword box 421, the information processing control section 20 replaces the input character displayed in the input character field 423 with the selected keyword “Montana”. If a different keyword has already been displayed in the input character field 423 by a previous operation, the keyword thus newly selected is displayed after the former keyword. Then, the information processing control section 20 narrows down the keywords thus selected and narrows down the destination candidates. For example, in a case in which the user has selected the keyword “Montana” in FIG. 19A, the keyword “Montana” is extracted. Furthermore, the other keywords “Maine” and “Mississippi” are removed.

FIG. 19B shows the destination setting screen shown in FIG. 19A after the keyword “Montana” has been selected. As shown in FIG. 19B, the letter “M” input in a frame in the input character field 423 is replaced by the selected keyword “Montana”, thereby displaying the keyword “Montana” in the frame. Furthermore, the keyword “Montana station” is extracted and the related keywords “golf” and “university” associated with the selected keyword “Montana” are displayed in the keyword box 421. It should be noted that, in displaying the related keywords, the related keywords are displayed in addition to the keywords in descending order of priority, after each priority level has been adjusted based upon the current circumstances (time, place, etc.), in the same way as in the first embodiment. As described above, in the same manner as in the first embodiment, the navigation apparatus modified to US specifications allows the user to search for a destination by repeated keyword selection from keywords displayed in the form of a list (menu).

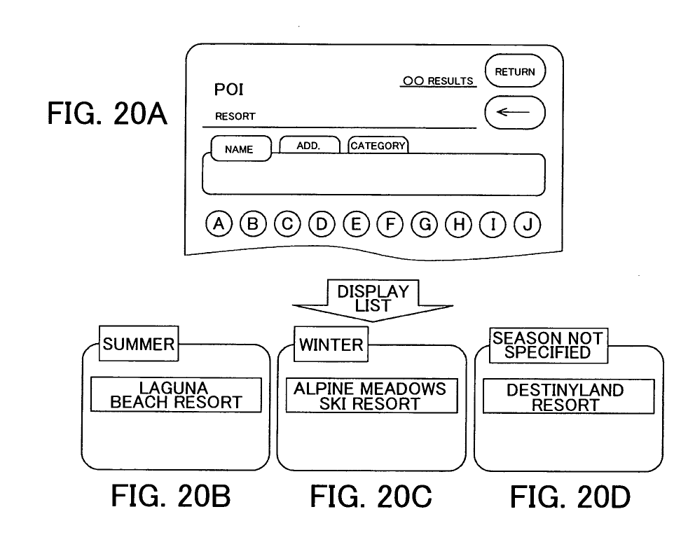

FIG. 20A through FIG. 27B show examples of different destination candidates displayed in the form of a list, based upon the priority scores adjusted according to the priority score adjustment rules shown in FIG. 4, in the navigation apparatus modified to US specifications. FIGS. 20A-20D show an example of different destination candidates displayed in the form of a list for which season adjustment rules are applied as the priority score adjustment rules. FIG. 20A shows the selected keyword “Resort” displayed in the input character field 423. When the user selects the completion (enter) key 427 in this state, if currently “summer”, the scores of the destination candidates which have been narrowed down and which are stored in the RAM 24 are adjusted according to the priority adjustment rules that raise the priority scores of the location candidates (destination candidates) including keywords associated with “summer”, in the same way as in the first embodiment. As a result, in this case, the destination candidate “Laguna Beach Resort” is displayed with high priority in a list, as shown in FIG. 20B. On the other hand, in a case in which the current season is “winter”, the destination candidate “Alpine Meadows Ski Resort” is displayed with high priority in the same way as shown in FIG. 20C. In a case in which the user has not specified “season” for priority adjustment, the destination candidate “Destinyland Resort”, for example, is displayed with high priority in a list as shown in FIG. 20D.

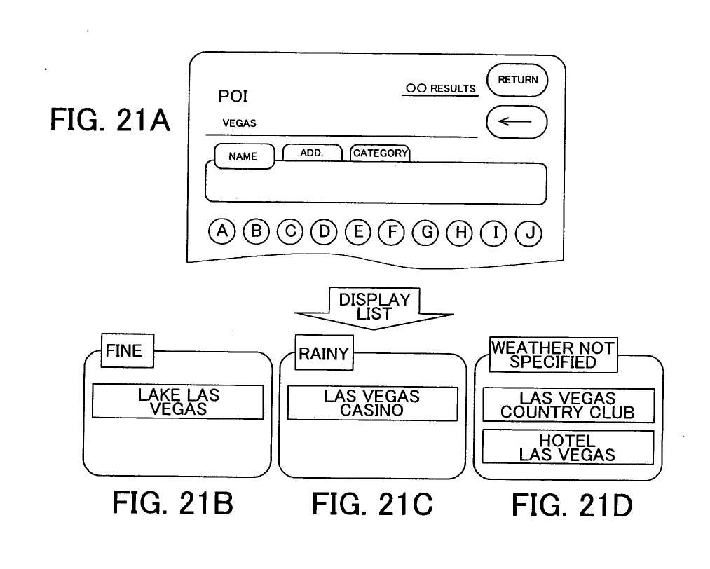

FIG. 21A -21D show an example of different destination candidates displayed in the form of a list to which weather adjustment rules have been applied as the priority score adjustment rules. As shown in FIG. 21A, when the user selects the completion (enter) key 427 with the input keyword “vegas” displayed in the input character field 423, if the local weather is currently “fine”, the destination candidate “Lake Las Vegas”, for example, is displayed with high priority according to the priority score adjustment rules, as shown in FIG. 21B. On the other hand, in a case in which the current weather is “rainy”, the destination candidate “Las Vegas Casino” is displayed with high priority in a list in the same way as shown in FIG. 21C. On the other hand, if the user has not specified the “weather” for priority adjustment, the destination candidates are displayed a list in order of, for example, “Las Vegas Country Club”, “Hotel Las Vegas”, etc., as shown in FIG. 21D.

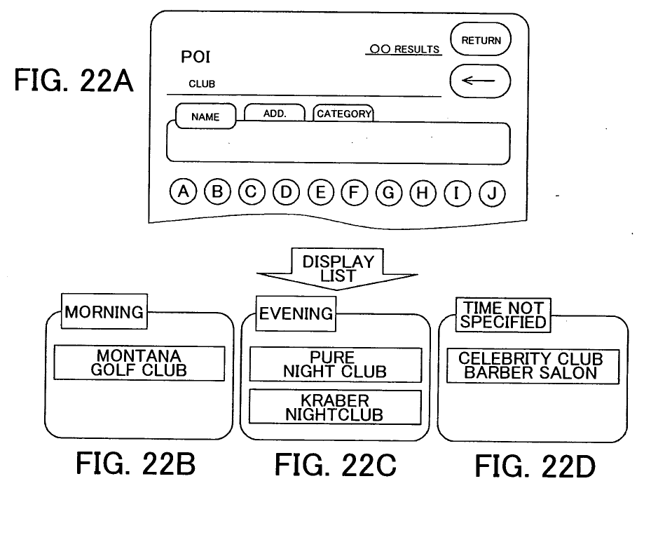

FIGS. 22A-22D show an example of different destination candidates displayed in the form of a list in a case in which time adjustment rules have been applied as the priority score adjustment rules. As shown in FIG. 22A, when the user operates the completion (enter) key 427 with the input keyword “club” displayed in the input character field 423, in a case in which the current time matches “morning”, the destination candidate “Montana Golf Club” is displayed with high priority in a list according to the priority score adjustment rules, as shown in FIG. 22B. On the other hand, in a case in which the current time matches “evening”, the destination candidates are displayed in the form of a list in the same way, in order of “Pure Night Club”, “Kraber Nightclub”, etc., as shown in FIG. 22C. In a case in which the user has not specified “time” for priority adjustment, the destination candidate “Celebrity Club Barber Salon” is displayed with high priority in a list as shown in FIG. 22D.

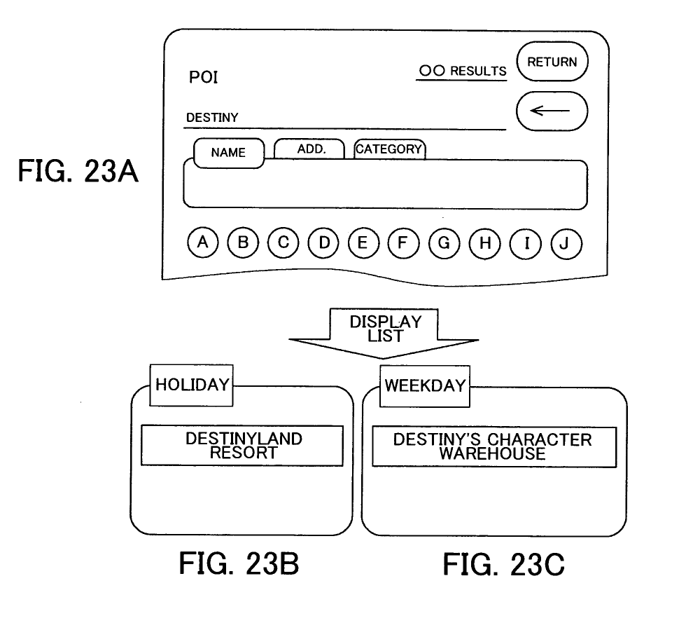

FIGS. 23A-23C show an example of different destination candidates displayed in the form of a list to which calendar adjustment rules have been applied as the priority score adjustment rules. As shown in FIG. 23A, when the user operates the completion (enter) key 427 with the input keyword “destiny” displayed in the input character field 423, if today is a holiday, the destination candidate “Destinyland Resort”, which is far from the current location, is displayed with high priority in a list as shown in FIG. 23B. On the other hand, if today is not a holiday, the destination candidate “Destiny's Character Warehouse”, which is a nearby location, is displayed with high priority in a list as shown in FIG. 23C.

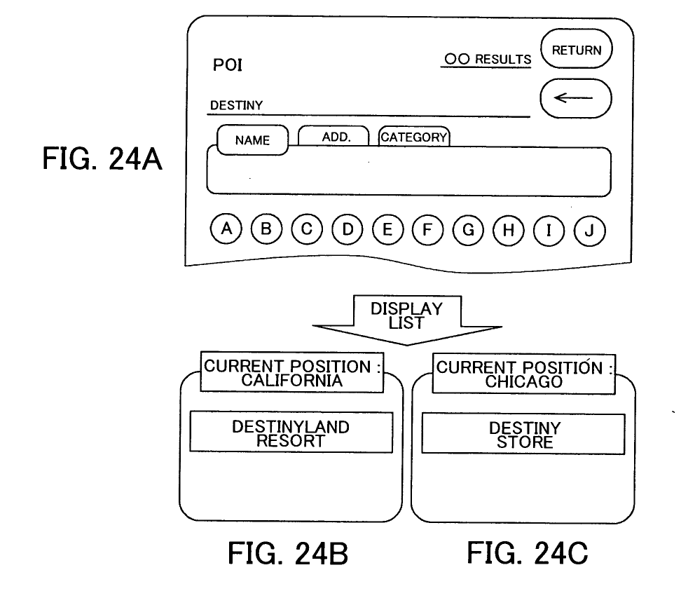

FIGS. 24A-24C show an example of different destination candidates displayed in the form of a list to which current location adjustment rules have been applied as priority score adjustment rules. As shown in FIG. 24A, when the user operates the completion (enter) key 427 with the input keyword “destiny” displayed in the input character field 423, assuming the current location is in California, “Destinyland Resort”, which includes a keyword associated with “California”, is displayed with high priority in a list as shown in FIG. 24B. On the other hand, if the current location is in Chicago, the “Destiny Store”, which includes a keyword associated with “Chicago”, is displayed with high priority in a list in the same way, as shown in FIG. 24C.

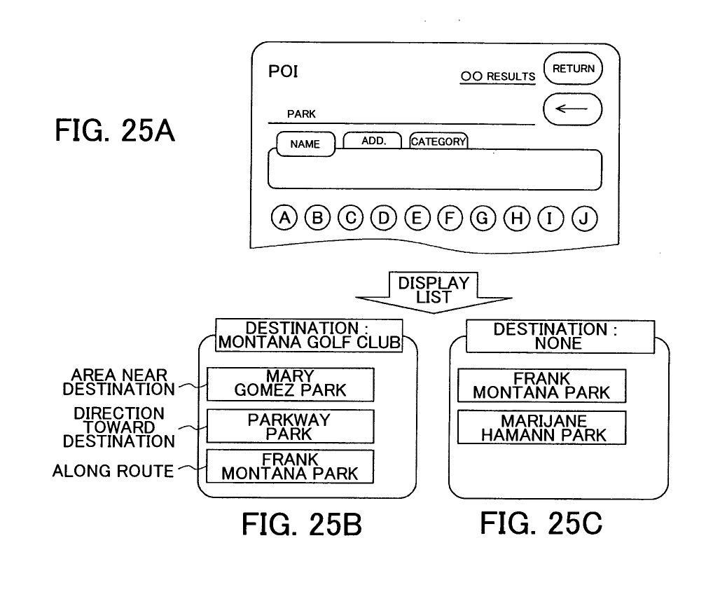

FIGS. 25A-25C show an example of different destination candidates displayed in the form of a list to which destination adjustment rules have been applied as the priority score adjustment rules. As shown in FIG. 25A, when the user operates the completion (enter) key 427 with the input keyword “park” displayed in the input character field 423, assuming “Montana golf club” has already been set as the destination, the location candidates are displayed in order of “Mary Gomez Park”, which is near the destination, “Parkway Park”, which is in the direction of travel toward the destination, “Frank Montana Park”, which is near the route, etc., as shown in FIG. 25B, according to the priority score adjustment rules which raise the priority levels of the location candidates near the destination, the location candidates in the direction of the destination, and the location candidates near the route to the destination. On the other hand, if the destination has not been set, the location candidates are displayed in order of, for example, “Frank Montana Park” and “Marijane Hamann Park”, which are in the vicinity of the current location.

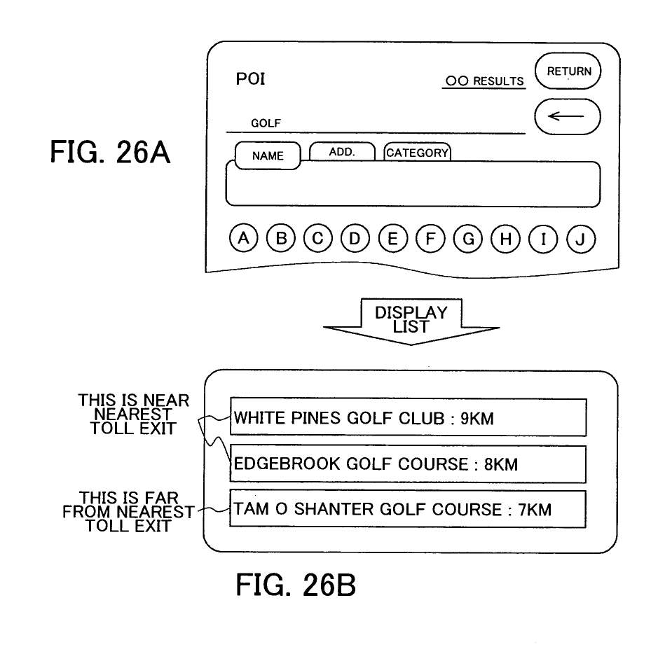

FIGS. 26A and 26B show an example of different destination candidates displayed in the form of a list and to which location adjustment rules have been applied as the priority score adjustment rules. As shown in FIG. 26A, when the user operates the completion (enter) key 427 with the input keyword “golf” displayed in the input character field 423, the destination candidates are displayed in ascending order of the distance between the location candidate and the nearest toll exit, e.g., in order of “White Pines Golf Club; 9 km”, “Edgebrook Golf Course; 8 km”, and “Tam O Shanter Golf Course; 7 km”, as shown in FIG. 26B. It should be noted that the distance information displayed in the list, i.e., “9 km”, “8 km”, and “7 km” are the distances between the respective places and the current location. However, “White Pines Golf Club” is displayed in the position of highest priority, notwithstanding distance from the current location, since the distance from the toll exit is shortest.

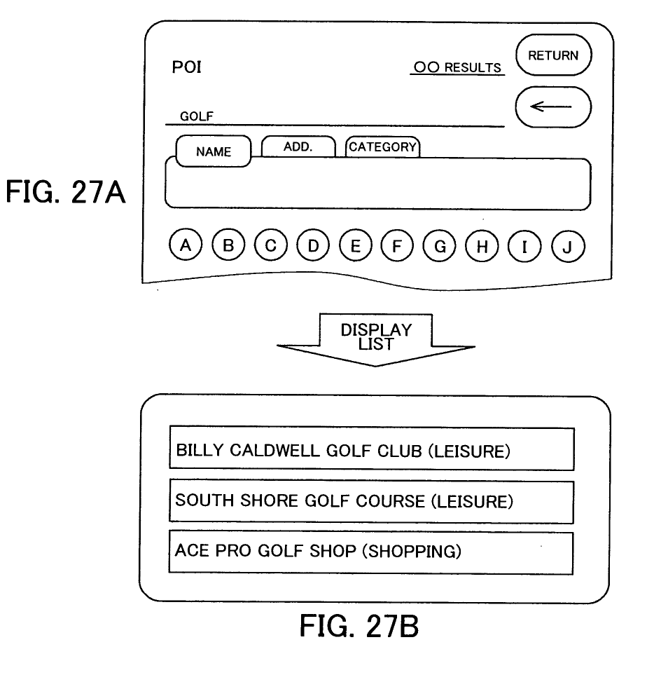

FIGS. 27A and 27B show an example of different destination candidates displayed in the form of a list when genre adjustment rules have been applied as the priority score adjustment rules. As shown in FIG. 27A, when the user operates the completion (enter) key 427 with the input keyword “golf” displayed in the input character field 423, the destination candidates are displayed in the form of a list after priority adjustment in order of “Billy Caldwell Golf Club; leisure”, “South Shore Golf Course; leisure”, “Ace Pro Golf Shop; shopping”, etc., as shown in FIG. 27B.

As described above, with the navigation apparatus modified to US specifications so as to allow the user to input alphabetical text data via the input character field 423, the listing order is adjusted according to the priority score adjustment rules in the same way as in the first embodiment, thereby allowing the destination candidates to be displayed in the form of a list in an order more suitable for the user.

The first and second embodiments of the navigation apparatus have been described as designed to Japanese and US specifications, respectively. However, the apparatus and method can be adapted to other target countries and regions. For example, the navigation apparatus may be modified to accommodate use in countries and regions, such as Germany, Spain, France, Arab countries, China, Korea, Australia, etc. The input device 41 includes an input keyboard 422 that supports the local language for the target country (region), and the specifications of each data set are defined of the target country (region). For example, with the navigation apparatus modified to Chinese specifications, the input device 41 includes an input keyboard 422 which supports the Chinese pinyin input method. The names of the items of the destination data, which have been determined for the target country or region for the navigation apparatus, are stored in the destination data file 56 in the local language.

The input target language does not necessarily need to be set to the local language in the target country (region) for the navigation apparatus. For example, a navigation apparatus that supports the German input method may be modified to French specifications. With such an arrangement, the search target data sets, which are searched in the destination search step, i.e., the reference data sets, which are compared with the input character in the destination search step (e.g., the names of destinations, keywords, addresses, etc.), are stored in the input-supported language in the destination data file 56 and the keyword data file 58. It should be noted that the search target data may also be stored in the local language for the target country (region), in addition to the input-supported language. It should also be noted that the data other than the search target data, which is not searched in the destination search step, e.g., additional information data, does not need to be stored in the input-supported language. Specifically, the data other than the search target data may be stored in either the input-supported language or the local language for the target country (region). Also, data other than the search target data may be stored in both the input-supported language and the local language of the target country (region).

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A navigation apparatus comprising:
a destination data storage unit which stores destination data as a search target;
a character input unit which allows characters to be input for making a search;
a search unit which searches for destination data including the input characters and identifies destinations for which destination data includes the input characters as destination candidates;
a priority determination unit which determines a priority level for display of each of the destination candidates thus identified, based upon content of each of the destination candidates and a current circumstance; and
a display unit which displays the destination candidates in descending order of the priority levels thus determined.

2. The navigation apparatus according to claim 1, wherein:
the priority determination unit adjusts the priority level assigned to the destination candidate according to adjustment rules for adjusting the priority level based upon the content of the destination candidate and the current circumstance.

3. The navigation apparatus according to claim 2, wherein the adjustment rules are defined for at least one of season, weather, time, relation to consecutive holidays, current location, destination, the distance between the nearest toll exit and the destination candidate, and genre.

4. A computer-readable medium encoded with a navigation program which instructs a computer to serve as:
a search unit which searches in a destination data storage unit responsive to input of characters, which stores destination data, and which identifies potential destinations, for which the destination data includes the input characters, as destination candidates; and
a priority determination unit which determines a priority level for display of each of the destination candidates thus searched based upon a content thereof and a current circumstance.
